(19) United States
(12) Patent Application Publication
(10) Pub. No.: US 2005/0287367 A1
(43) Pub. Date: Dec. 29, 2005

(54) Cushioning packing spiral

(75) Inventor: Ming-Te Lai, Yonghe City (TW)

Correspondence Address: TROXELL LAW OFFICE PLLC, SUITE 1404, 5205 LEESBURG PIKE, FALLS CHURCH, VA, 22041, US

(73) Assignee: Jean Card and Gift Co., Ltd.

(21) Appl. No.: 11/149,253

(22) Filed: Jun. 10, 2005

(30) Foreign Application Priority Data
Jun. 25, 2004 (TW) 093210007

(51) Int. Cl. B32B 5/00

(52) U.S. Cl. 428/371; 428/98

(57) ABSTRACT

A cushioning packing spiral is formed from a long strip of material having a predetermined width and continuously coiled using a spiral-forming machine and cut into different lengths using a rear-mounted cutting mechanism. The cushioning packing spiral has a spiral pitch to provide desired axial tensile elasticity and radial height, so that a plurality of the cushioning packing spirals may be randomly positioned in a packing container to form a cushioning layer, which provides not only changeful decorating effects, but also good air permeability and buffering effect in the packing container.

### FIELD OF THE INVENTION

The present invention relates to a packing material, and more particularly to a spiral-shaped cushioning packing material functioning like a cushion spring to provide good buffering and damping effect, good air permeability, and good decoration when being used in a packing container.

### BACKGROUND OF THE INVENTION

Shredded papers are narrow and long paper strips obtained by cutting sheets of paper using a shredding machine, and are often used in a packing container for gift or fruit to create increased value and attractive appearance, as well as provide required cushioning or damping function for the packing container.

Such shredded papers used as cushioning packing material are usually straight and planar paper strips, and are normally arbitrarily laid in the packing container over an inner bottom thereof. In this manner, the shredded papers generally work as a decoration rather than a cushion layer.

FIGS. 1 and 2 are perspective and sectional views, respectively, showing the use of shredded papers 100 in a packing container 101 to form a cushioning and packing layer for supporting various kinds of products 102 thereon.

The shredded papers 100 are arbitrarily and disorderly positioned in the packing container 101 to on the one hand highlight and decorate the products 102 supported thereon, and on the other hand provide a loose and soft layer having a cushioning function. Since the shredded papers 100 are soft and lightweight, they are particularly suitable for forming a cushioning and packing layer without increasing the freight cost, as compared to other conventional packing materials that are bulky and heavy.

However, since the shredded papers 100 are straight and planar paper strips, they are less attractive in terms of the decorating effect. Moreover, the soft and loose cushioning and packing layer formed from the straight and planar shredded papers 100 tends to become flattened and lose the cushioning and packing function when the shredded papers 100 are subjected to pressure from the products 102 supported thereon. In the case of heavy products 102, such as fruits, it is very possible the products 102 contact at a bottom with the packing container 101 on the way of transporting or when being displayed, and therefore become damaged due to collision with the container 101 or become rotten due to poor air permeability in the container 101.

### SUMMARY OF THE INVENTION

A primary object of the present invention is to provide a cushioning packing spiral that not only creates beautiful and changeful decorating effects, but also provides largely improved air permeability and cushioning function in a packing container.

To achieve the above and other objects, the cushioning packing spiral according to the present invention is formed from a long strip of material that has a predetermined width and are continuously coiled using a spiral-forming machine. The cushioning packing spiral has a spiral pitch to produce desired axial tensile elasticity and radial height.

In a preferred embodiment of the present invention, a plurality of the cushioning packing spirals may be randomly positioned in a packing container to form a cushioning layer.

In a feasible embodiment of the present invention, the long strip of material for forming the cushioning packing spiral is a paper strip.

In another feasible embodiment of the present invention, the long strip of material for forming the cushioning packing spiral is a plastic film.

In a further feasible embodiment of the present invention, the cushioning packing spiral is cut into predetermined lengths using a cutting mechanism mounted behind the spiral-forming machine.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing that shredded papers are conventionally used as packing material in a packing container to support products thereon;

FIG. 2 is a sectional view of FIG. 1;

FIG. 3 schematically shows the forming of a cushioning packing spiral according to a preferred embodiment of the present invention;

FIG. 4 is a fragmentary front view of the cushioning packing spiral of FIG. 3;

FIG. 5 is an end view of FIG. 4;

FIG. 6 is a perspective view showing that a plurality of cushioning packing spirals of the present invention are positioned in a packing container to support products thereon;

FIG. 7 is a sectional view of FIG. 6;

FIG. 8 is an end view of the cushioning packing spirals of the present invention with products supported thereon; and

FIG. 9 shows the cushioning packing spirals of FIG. 8 in a compressed state.

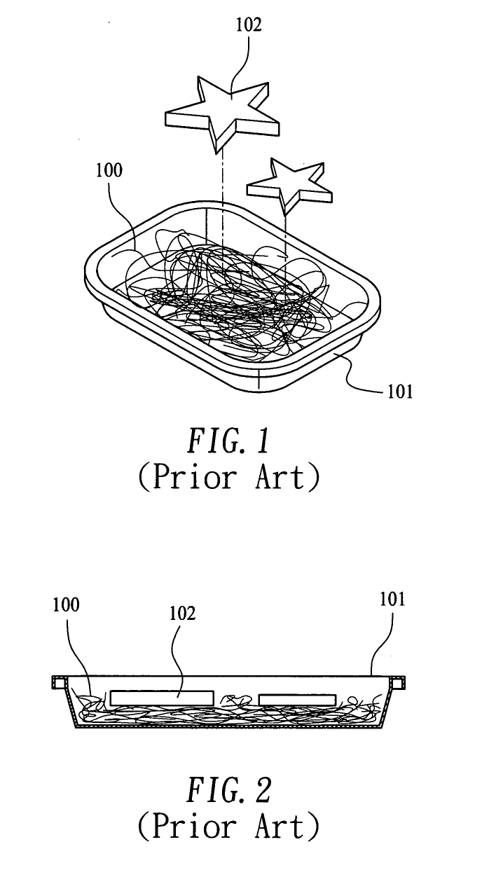

### DETAILED DESCRIPTION OF THE PREFERRED EMBODIMENTS

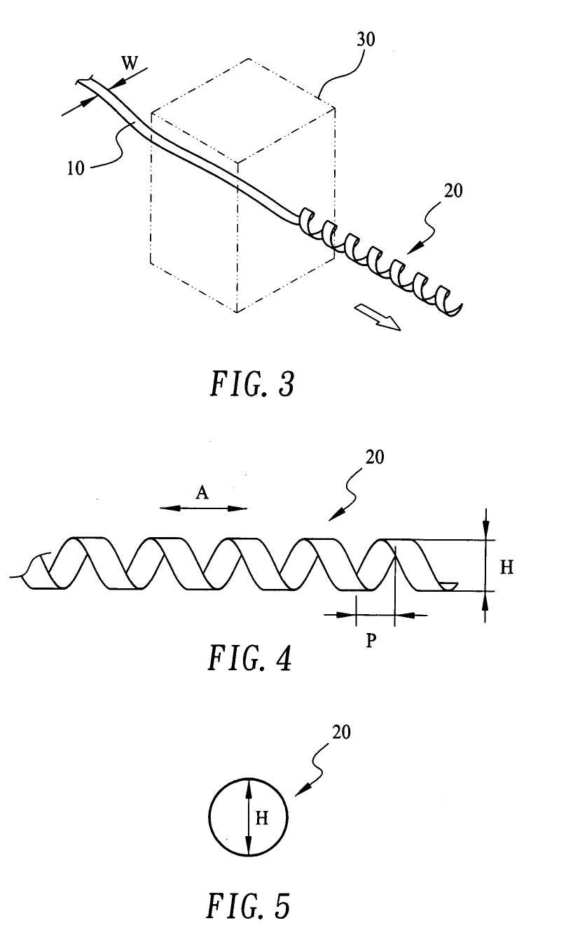

Please refer to FIG. 3 that is a perspective view showing the forming of a cushioning packing spiral 20 according to a preferred embodiment of the present invention. As shown, to form the cushioning packing spiral 20, a long strip of material 10 having a predetermined width W is continuously spiraled using a spiral-forming machine 30. When the long strip of material 10 is a paper strip, the produced cushioning packing spiral 20 is functionally similar to a “paper spring”.

While the long strip of material 10 is preferably a paper strip, it may be of any other suitable material, such as a plastic film. Since the cushioning packing spiral 20 of the present invention may be made of a variety of strip materials, changeful decorating effects may be presented with the cushioning packing spirals 20.

The long strip of material 10 usually has a very small thickness, and could not be spiraled in a manner that is usually used to spiral a rigid material. The thin and soft strip of material 10 must be guided through a coiler in the spiral-forming machine 30 to form continuous coils, and then cut to desired lengths using a rear-mounted cutting mechanism.

Please refer to FIGS. 4 and 5 that are front and end views, respectively, of the cushioning packing spiral 20 of the present invention. The cushioning packing spiral 20 formed in the above-described manner may have different spiral pitches P and heights H to produce desired tensile elasticity in the axial direction A. The spiral pitch P also provides a space for two layers of cushioning packing spirals 20 to closely contact with or overlap each other.

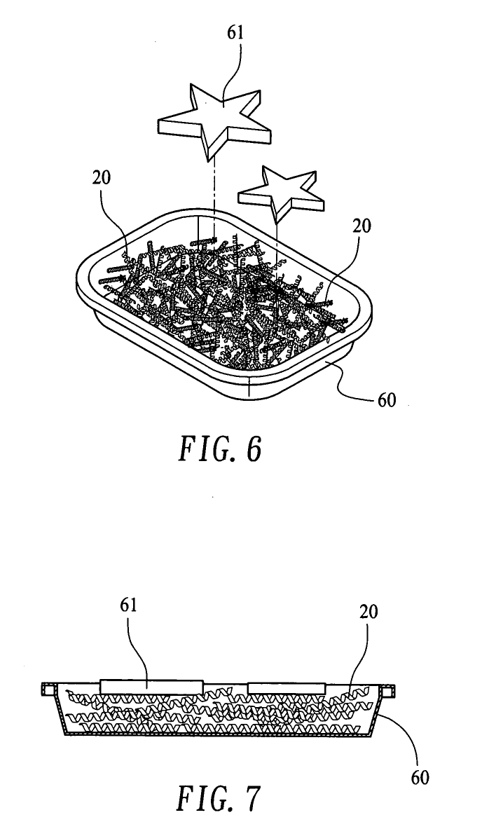

As can be seen from FIG. 6, a plurality of cushioning packing spirals 20 may be randomly positioned in a packing container 60 over an inner bottom thereof, so as to form a cushion layer in the packing container 60 for supporting desired products 61 thereon. The cushioning packing spirals 20 positioned in the same packing container 60 may be cut into the same or different lengths, have the same or different colors, and be made of the same or different materials. FIG. 7 is a sectional view of FIG. 6.

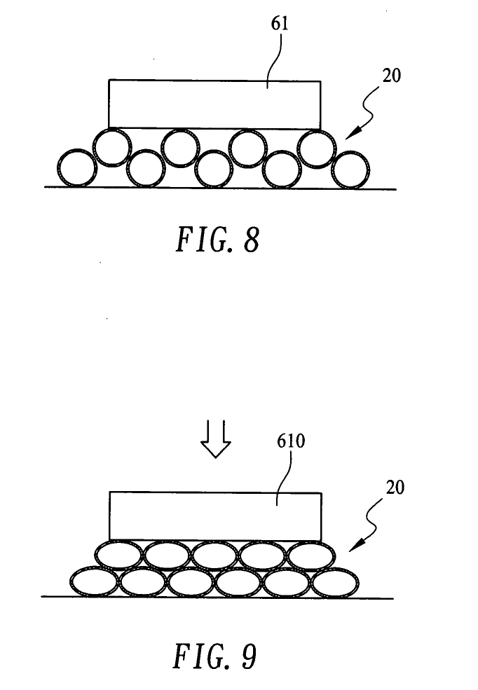

Please refer to FIG. 8. When the products 61 packed in the packing container 60 are lightweight items, the cushioning packing spirals 20 positioned over the bottom of the packing container 60 naturally form a decorative and cushioning packing layer for the products 61.

On the other hand, when a relatively heavy product 610 is positioned on the cushioning packing spirals 20 or a force is applied to the cushioning packing spirals 20 in a direction as indicated by the arrow in FIG. 9, the radial height H and the distance between the spiral pitches P of the cushioning packing spirals 20 together provide sufficient spaces among the cushioning packing spirals 20 to enable good air permeability and buffering effect in the packing container.

In brief, the cushioning packing spiral 20 of the present invention may be advantageously made of different materials and cut into different lengths to provide not only beautiful and changeful decorating effects, but also good tensile elasticity like a spring to ensure good air permeability and buffering functions.

The present invention has been described with a preferred embodiment thereof and it is understood that many changes and modifications in the described embodiment can be carried out without departing from the scope and the spirit of the invention that is intended to be limited only by the appended claims.

1. A cushioning packing spiral, comprising a long strip of material that has a predetermined width and is continuously spiraled using a spiral-forming machine into a spiral-shaped strip, and said spiral-shaped strip having a predetermined spiral pitch to provide required axial tensile elasticity and radial height.

2. The cushioning packing spiral as claimed in claim 1, wherein a plurality of said spiral-shaped strips may be randomly positioned in a packing container to provide a cushioning and packing layer in said packing container.

3. The cushioning packing spiral as claimed in claim 1, wherein said long strip of material for forming said spiral-shaped strip is a long strip of paper.

4. The cushioning packing spiral as claimed in claim 1, wherein said long strip of material for forming said spiral-shaped strip is a long strip of plastic film.

5. The cushioning packing spiral as claimed in claim 1, wherein said spiral-shaped strip is cut into different lengths using a cutting mechanism located at a rear side of said spiral-forming machine.
